(19) United States
(12) Patent Application Publication
(10) Pub. No.: US 2025/0290514 A1
(43) Pub. Date: Sep. 18, 2025

(54) MOTOR COOLING IN SCREW COMPRESSORS

(71) Applicant: Carrier Corporation, Palm Beach Gardens, FL (US)

(72) Inventors: Yifan Qiu, Manlius, NY (US); David Rockwell, Cicero, NY (US); Scott Krawec, Salisbury Center, NY (US)

(21) Appl. No.: 19/077,392

(22) Filed: Mar. 12, 2025

Related U.S. Application Data
(60) Provisional application No. 63/566,700, filed on Mar. 18, 2024.

(51) Int. Cl. F04C 29/04; F04C 18/16

(52) U.S. Cl. CPC F04C 29/045; F04C 18/16; F04C 2210/24; F04C 2240/60

(57) ABSTRACT

Described herein is a motor for a compressor. The motor comprises a rotor configured over a shaft, a stator arranged around the rotor within a cover associated with the motor, and at least one fluid injection device, wherein the at least one fluid injection device has a shape and comprises an inlet port, and one or more outlet ports configured at positions on the corresponding fluid injection device, the one or more outlet ports being fluidically connected to the inlet port via a plurality of fluidic passages extending within the corresponding fluid injection device, wherein the inlet of each of the at least one fluid injection device is fluidically connected to a fluid injection passage extending through the cover.

### CROSS-REFERENCE TO RELATED APPLICATION

This patent application claims the benefit of U.S. Provisional Patent Application No. 63/566,700, filed on Mar. 18, 2024, which is incorporated by reference herein in its entirety.

### BACKGROUND

This subject disclosure relates to the field of screw compressors or semi-hermitic screw compressors, and more particularly, a cooling system for motors associated with screw compressors or semi-hermetic screw compressors.

### SUMMARY

Described herein is a motor for a compressor. The motor comprises a rotor configured over a shaft, a stator arranged around the rotor within a cover associated with the motor, and at least one fluid injection device, wherein the at least one fluid injection device comprises an inlet port and one or more outlet ports, wherein the one or more outlet ports are fluidically connected to the inlet port via a plurality of fluidic passages extending within the corresponding fluid injection device, and wherein the inlet port of each of the at least one fluid injection device is fluidically connected to a corresponding fluid injection passage extending through the cover.

In one or more embodiments, the compressor is a screw compressor, wherein the at least one fluid injection device is configured at one or both ends of the shaft.

In one or more embodiments, the compressor is a semi-hermetic screw compressor having a first section of the shaft extending out of a housing of the compressor into the cover, and a second section of the shaft enclosed within the housing.

In one or more embodiments, the at least one fluid injection device is configured to flow or spray a refrigerant towards the stator and/or the rotor, at one or both ends of the shaft or the first section of the shaft, through the one or more outlet ports via the corresponding fluidic passages.

In one or more embodiments, a ring-shaped fluid injection device among the at least one fluid injection device is fluidically connected to the corresponding fluid injection passage of the cover at one end of the shaft.

In one or more embodiments, a ring-shaped fluid injection device among the at least one fluid injection device is fluidically connected with the corresponding fluid injection passage in the housing at an end of the first section of the shaft or an end of the shaft coaxially extending through the ring-shaped fluid injection device.

In one or more embodiments, the inlet port is configured axially on a planar side of the ring-shaped member of the at least one fluid injection device, and the one or more outlet ports are configured radially along an outer curved surface of the corresponding ring-shaped member.

In one or more embodiments, the inlet port and the one or more outlet ports are configured radially at positions along an outer curved surface of a corresponding ring-shaped member of the at least one fluid injection device.

In one or more embodiments, the inlet port is configured radially on an outer curved surface of a ring-shaped member of the at least one fluid injection device, and the one or more outlet ports are configured axially at positions along a planar surface of the corresponding ring-shaped member.

In one or more embodiments, a disc-shaped fluid injection device among the at least one fluid injection device is configured with the cover at an end of the shaft, wherein the inlet port and the one or more outlet ports are defined radially and/or axially along an outer curved surface and/or a planar surface respectively of the disc-shaped fluid injection device.

In one or more embodiments, the at least one fluid injection devices comprises one or more mounting holes that are configured to fluidically connect the inlet port of the at least one fluid injection device to the corresponding fluid injection passage and to the cover and/or a housing of the motor using one or more fasteners.

In one or more embodiments, the size of the one or more outlet ports is less than the size of the inlet port.

In one or more embodiments, the at least one fluid injection device is coaxially configured with the shaft, wherein the one or more outlet ports are positioned above a plane passing through a center of the shaft.

Also described herein is a motor for a semi-hermetic screw compressor associated with a vapor compression system. The motor comprises a shaft rotatably configured within a housing associated with the compressor, such that a first section of the shaft extends out of the housing and a second section of the shaft remains enclosed within the housing. The motor further comprises a stator and a rotor arranged around the first section of the shaft, wherein the stator, the rotor, and the first section of the shaft are enclosed by a cover being attached to the housing, and at least one fluid injection device configured at one or both ends of the first section of the shaft, wherein the at least one fluid injection device comprises an inlet port, and one or more outlet ports, the one or more outlet ports being fluidically connected to the inlet port via a plurality of fluidic passages extending within the corresponding fluid injection device, and wherein the inlet port of each of the at least one fluid injection device is fluidically connected to a corresponding fluid injection passage extending through the cover and/or the housing of the motor.

In one or more embodiments, wherein the at least one fluid injection device is configured to flow or spray a refrigerant towards the stator and/or the rotor, at one or both ends of the shaft or the first section, through the one or more outlet ports via the corresponding fluidic passages.

In one or more embodiments, a ring-shaped fluid injection device among the at least one fluid injection device is fluidically connected to the corresponding fluid injection passage of the cover at one end of the shaft.

In one or more embodiments, a ring-shaped fluid injection device among the at least one fluid injection device is is fluidically connected with the corresponding fluid injection passage in the housing at an end of the first section of the shaft or an end of the shaft coaxially extending through the ring-shaped fluid injection device.

In one or more embodiments, the inlet port is configured axially on a planar side of the ring-shaped member of the at least one fluid injection device, and the one or more outlet ports are configured radially at the positions along an outer curved surface of the corresponding ring-shaped member.

In one or more embodiments, the size of the one or more outlet ports is greater than the size of the inlet port.

In one or more embodiments, the at least one fluid injection device is coaxially configured at the one or both ends of the first section of the shaft, wherein the one or more outlet ports are positioned above a plane passing through a center of the shaft.

The foregoing summary is illustrative only and is not intended to be in any way limiting. In addition to the illustrative aspects, embodiments, and features described above, further aspects, embodiments, features, and techniques of the subject disclosure will become more apparent from the following description taken in conjunction with the drawings.

### BRIEF DESCRIPTION OF THE DRAWINGS

The accompanying drawings are included to provide a further understanding of the subject disclosure and are incorporated in and constitute a part of this specification. The drawings illustrate exemplary embodiments of the subject disclosure and, together with the description, serve to explain the principles of the subject disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary side cross-sectional view of a motor associated with a semi-hermetic screw compressor, where the motor is equipped with a cooling system comprising fluid injection devices, in accordance with one or more embodiments of the subject disclosure.

FIG. 2 illustrates an exemplary representation of a refrigerant line associated with the compressor of FIG. 1, in accordance with one or more embodiments of the subject disclosure.

FIGS. 3A to 3H illustrate exemplary views of one or more embodiments of the ring-shaped fluid injection device used in the motor of FIG. 1, in accordance with one or more embodiments of the subject disclosure.

### DETAILED DESCRIPTION

The following is a detailed description of embodiments of the subject disclosure depicted in the accompanying drawings. The embodiments are in such detail as to clearly communicate the subject disclosure. However, the amount of detail offered is not intended to limit the anticipated variations of embodiments; on the contrary, the intention is to cover all modifications, equivalents, and alternatives falling within the spirit and scope of the subject disclosure as defined by the appended claims.

Various terms are used herein. To the extent a term used in a claim is not defined below, it should be given the broadest definition persons in the pertinent art have given that term as reflected in printed publications and issued patents at the time of filing.

In the specification, reference may be made to the spatial relationships between various components and to the spatial orientation of various aspects of components as the devices are depicted in the attached drawings. However, as will be recognized by those skilled in the art after a complete reading of the subject disclosure that the components described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, described herein may be oriented in any desired direction.

Screw compressors or semi-hermetic refrigerant screw compressors are widely used in refrigeration and air conditioning systems due to their efficiency and reliability. These compressors rely on a motor enclosed within the same housing as the compressor mechanism, making the unit compact and less susceptible to leaks. However, the operation of these compressors generates significant heat, which is to be managed to maintain efficiency and prevent damage. Specifically, the motor within the compressor may require cooling to prevent overheating, which may lead to failure.

Traditionally, cooling of the motor in screw compressors may be achieved by injecting a liquid refrigerant into the compressor housing. This liquid may typically be injected through ports located in the motor housing and the motor cover, allowing the refrigerant to come into direct contact with the motor, thereby absorbing heat and cooling the motor. However, due to space constraints within the compressor housing, the number of ports through which the refrigerant may be injected is limited, often to one port in the motor housing and one port in the motor cover. This limitation may result in uneven cooling of the motor, as the refrigerant may not be distributed evenly across all parts of the motor.

Areas of the motor that receive less cooling may be prone to local overheating, which may degrade the motor's performance over time and ultimately lead to motor failure. Furthermore, the traditional approach to motor cooling in screw compressors may not be optimized for efficiency. The injection of too much refrigerant through the motor may cause additional viscous losses, further reducing the overall efficiency of the compressor.

Therefore, there exists a need for an improved and space-efficient motor cooling system for screw compressors or semi-hermetic refrigerant screw compressors that addresses the issue of uneven motor cooling and overheating, while also improving the efficiency of the motor cooling process.

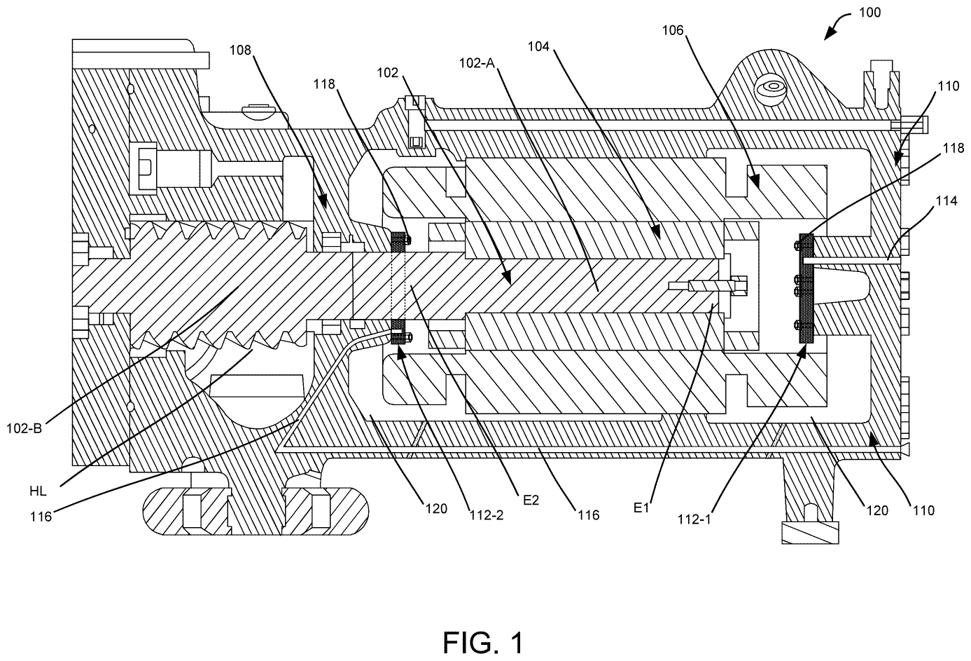

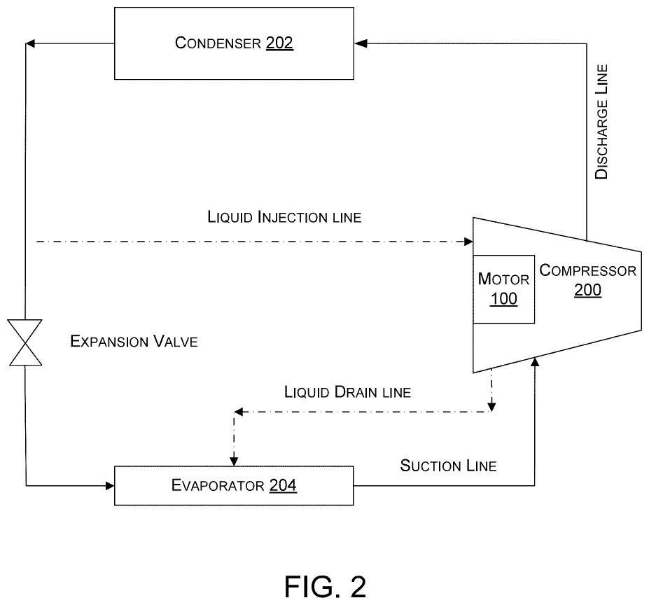

Referring to FIGS. 1 and 2, an electric motor 100 (also referred to as a motor 100, hereinafter) associated with a screw compressor 200 (referred to as compressor 200, hereinafter) is disclosed. In one or more embodiments, the compressor 200 may be a semi-hermetic screw compressor or a bottom suction semi-hermetic screw compressor, but not limited to the like. However, in other embodiments, the compressor 200 may also be any other type of screw compressor without any limitations. In one or more embodiments, the motor 100 may be integrated within an enclosure of the compressor 200. However, in other embodiments, the motor 100 may have a separate enclosure that may be fluidically connected to the enclosure of the compressor 200.

In one or more embodiments, in the semi-hermetic screw compressor 200, a shaft 102 associated with a male rotor may be rotatably configured within a housing 108 (enclosure) of the compressor 200, such that a first section 102-A of the shaft 102 extends out of the housing 108 and a second section 102-B of the shaft 102 remains enclosed within the housing 108. In one or more embodiments, the first section 102-A may be attached to an end of the second section 102-B, however, the second section 102-B and the first section 102-A may also be integral (or integrally connected) to form the shaft 102.

Further, the second section 102-B of the shaft 102 may include a helical lobe (HL) forming a screw type profile that may enmesh with another helical lobe (not shown) formed on a female rotor (not shown) associated with the semi-hermetic screw compressor 200. Furthermore, in the compressor 200, the female rotor and the second section 102-B of the male rotor may be enclosed within the same housing 108. In one or more embodiments, the shaft 102 may be driven for rotation about its axis by the motor 100. The driving of the male rotor may cause the engagement between lobes to, in turn, enable rotation of the female rotor about its axis. In one or more embodiments, the female rotor and the second section 102-B of the male rotor may be rotatably supported within the housing 108 using one or more bearings (not shown) to allow rotation of the male and female rotors about their corresponding axis.

The motor may further include rotor 104 comprising a plurality of rotor elements configured around the first section 102-A of the shaft 102, where the rotor elements may be configured to rotate along with the shaft 102. The motor 100 may further include a stator 106 comprising a stator stack having a plurality of stator windings arranged around the first section 102-A of the rotor 104, such that the stator windings and the first section 102-A of the rotor 104 remain enclosed within a cover 110. This cover 110 may be further attached to the housing 108 using one or more fasteners. However, in some embodiments, the cover 110 of the motor 100 and the housing 108 may also be integral.

The motor 100 may be configured to be electrically connected to a power supply that may provide electric current to the stator windings to induce an electromagnetic field within the stator windings, resulting in a rotational motion of the rotor 104 and shaft 102 about its axis. In the compressor 200, the two meshing rotors (male and female) comprising helical lobes interlocked within the housing 108 of the compressor 200, may create a series of decreasing volume chambers between them. As the rotors rotate, gas (refrigerant) may be drawn into the housing 108 through an intake end (not shown). The meshing motion of the rotors may then force the gas through the compressor 200, progressively reducing the volume of the chambers and thus compressing the gas. This continuous, valveless compression process may result in a steady flow of compressed gas being pushed towards a discharge end (not shown) of the compressor 200, where it exits at a higher pressure for use in refrigeration, air conditioning, or industrial applications.

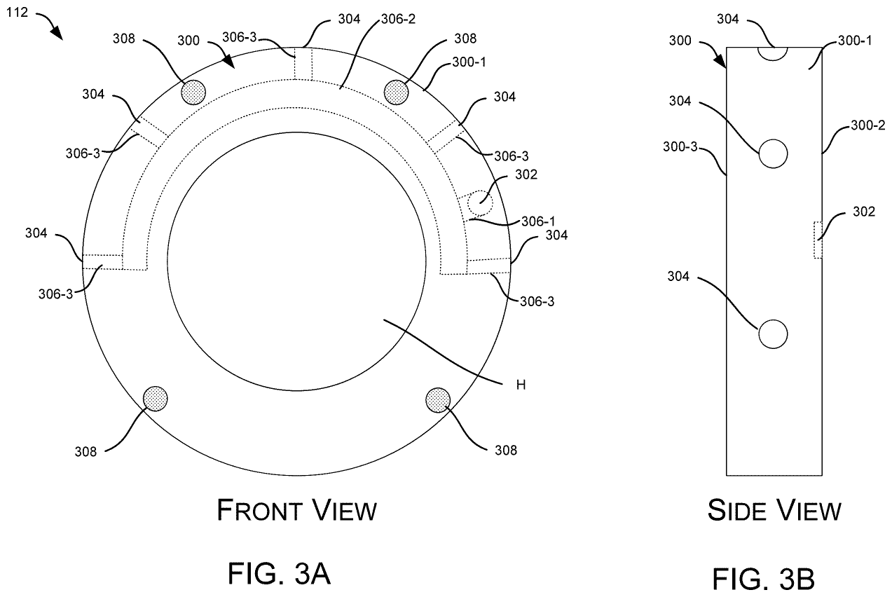

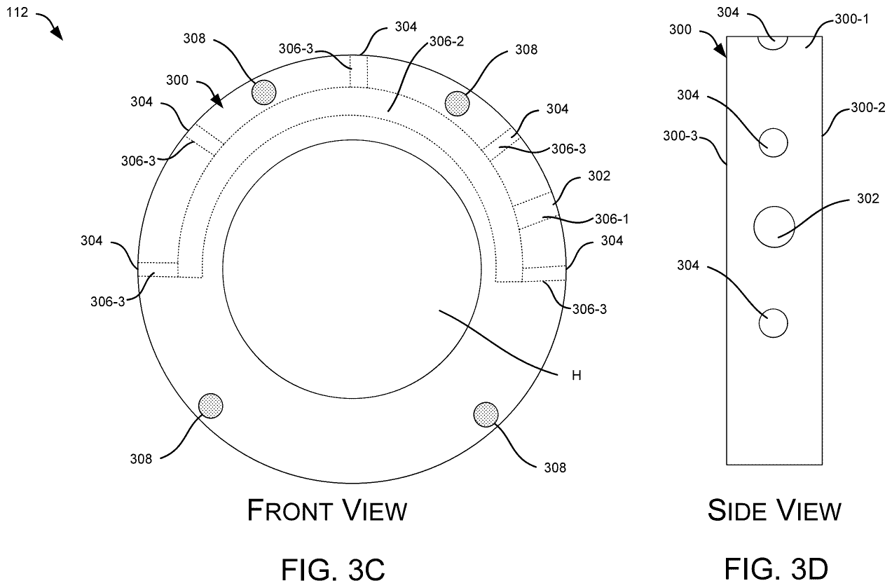

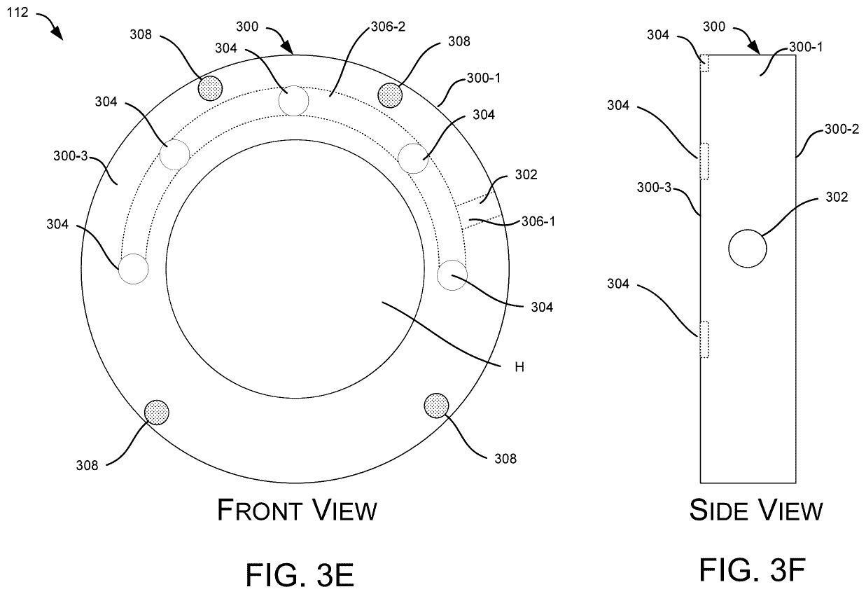

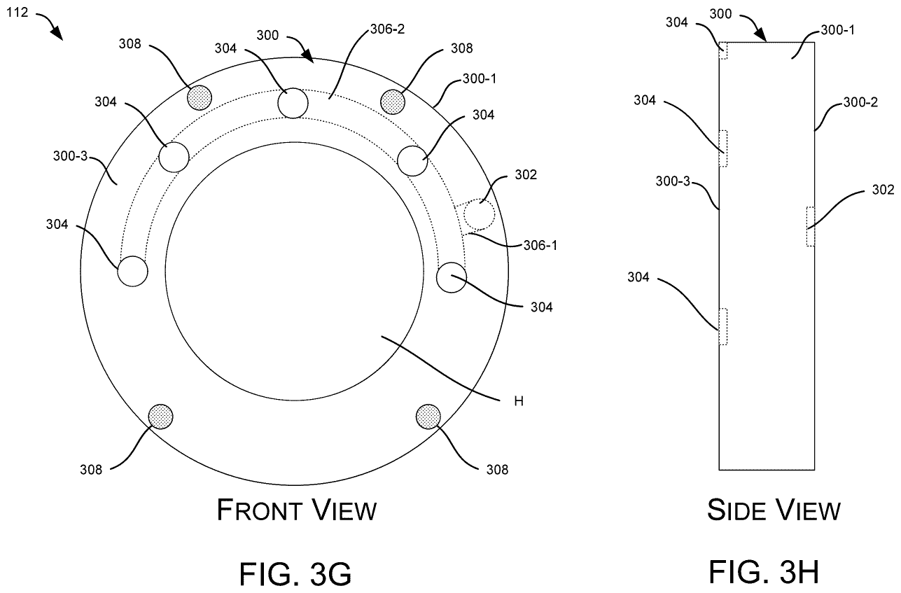

In one or more embodiments, the motor 100 may include at least one fluid injection device 112-1, 112-2 (collectively referred to as fluid injection device 112 or injection device 112, herein) configured at one or both ends E1, E2 of the first section 102-A of the shaft 102. Each of the injection device 112 may include an inlet port 302, and one or more outlet ports 304 configured at different positions on the corresponding injection device 112 as shown in detail in FIGS. 3A to 3H, where the outlet ports 304 may be fluidically connected to the inlet port 302 via a plurality of fluidic passages (web of passages) 306-1 to 306-3 extending within the body 300 of the corresponding injection device 112. Further, referring back to FIG. 1, the motor 100 may include one or more fluid injection passages 114, 116 extending through the cover 110 and/or the housing 108. These fluid injection passages 114, 116 may allow a refrigerant associated with the compressor 200 to flow within the cover 110. Further, in one or more embodiments, the fluid injection devices 112 may be configured coaxially to the shaft 102 at one or both ends E1, E2 of the first section 102-A of the shaft 102 such that the inlet 302 of each of the injection devices 112 remains fluidically connected to the fluid injection passage 114, 116 extending through the cover 110 and/or the housing 108. However, in other embodiments, the fluid injection devices 112 may not be coaxial to the shaft 102 but the inlet 302 of each of the injection devices 112 may remain fluidically connected to the fluid injection passage 114, 116 extending through the cover 110 and/or the housing 108.

In one or more embodiments, a first injection device 112-1 among the at least one injection device may be configured with the cover 110 at the first end E1 (away from the housing 108) of the first section 102-A of the shaft 102 such that the first injection device 112-1 remains fluidically connected to a first fluid injection passage 114 provided in the cover 110. Further, a second injection device 112-2 among the at least one injection device may be configured with the housing 108 or cover 110 at a second end (opposite to the first end) E2 of the first section 102-A of the shaft 102 such that the second injection device 112-2 remains fluidically connected to a second fluid injection passage 116 provided in the housing 108 or the cover 110, with the shaft 102 extending coaxially through a central hole H of the second injection device 112-2. However, in some embodiments, the center of the second injection device 112-2 may not be aligned with the central axis of the shaft 102. As illustrated, the second fluidic passage 116 may enter the housing 108 from the first end E1 (of the cover 110) and further gets connected to the inlet 302 of the second injection device 112-2 through the passage provided in the housing 108. However, the second fluidic passage 116 may also directly enter and extend through the housing 108 without traveling through the cover 110 of the motor 100.

The motor 100 or compressor 200 may be configured to enable the refrigerant associated with the compressor 200 to flow into the fluid injection devices 112 through the inlet port 302 via the fluid injection passage 114 provided in the cover 110 and/or the housing 108 of the motor 100. Further, the fluid injection devices 112 may enable the received (incoming) refrigerant to flow or spray towards the stator 106 and/or the rotor 104, at the one or both ends E1, E2 of the shaft 102 or the first section 102-A, through the outlet ports 304. Accordingly, the supplied/sprayed refrigerant may facilitate in uniform cooling of the stator 106 and the rotor 104 from both ends E1, E2 within the cover 110.

Referring back to FIG. 1, in one or more embodiments, the cover 110 of the motor 100 may include a drain area 120 configured at the bottom to receive and collect the refrigerant drained from the stator 106 and/or the rotor 104, along with any refrigerant leaked within the motor 100. Further, the motor 100 may be configured to enable the supply of the drained refrigerant into a liquid drain line associated with the compressor 200 or a refrigerant line in which the compressor 200 is employed. Referring to FIG. 2, the liquid drain line may be further connected to an evaporator 204 being fluidically connected to the compressor 200 in the refrigerant line. Further, the fluid injection device 112 or fluid injection passages provided in the housing 108 or cover 110 may be fluidically connected to a liquid injection line connected to a condenser 202 being fluidically connected to the compressor 200 in the refrigerant line. Accordingly, the motor 100 may receive cool liquid refrigerant from the condenser 202 via the liquid injection line, and further return the refrigerant collected within the motor's housing 108 or cover 110 back to the refrigerant line (via the drain line) along with the vapor phase of the refrigerant (formed within the evaporator 204).

In one or more embodiments, the first and second fluid injection devices 112 may be a ring-shaped member comprising the inlet port 302 and the outlet ports 304. Further, in some embodiments, the first fluid injection device 112-1 may also be a disc-shaped member comprising the inlet port 302 and the outlet ports 304 configured with the cover at an end of the shaft 102. However, the second fluid injection device 112-2 has to be a ring-shaped member such that the shaft 102 may extend coaxially through a central hole H of the ring-shaped member to allow uninterrupted rotation of the shaft 102 about its axis, with the first and second fluid injection devices 112-1, 112-2 being coaxially positioned at each end E1, E2 of the first section 102-A of the shaft 102.

Referring to FIGS. 3A and 3B, front and side views of the ring-shaped fluid injection devices 112 are shown. In one or more embodiments, the fluidic passages within the ring-shaped member 300 may include a first path 306-1 extending at least partially within the member 300 in an axial direction from the inlet port 302. The fluidic passages may further include a second path 306-2 connected to the first path 306-1 and extending circumferentially between each of the outlet ports 304 within the ring-shaped member 300 along a plane (perpendicular to the axial direction) of the ring-shaped member. Further, the fluidic passage may include one or more third paths 306-3, each extending from the second path 306-2 in a radial direction towards one of the outlet ports 304 such that all the outlet ports 304 remain fluidically connected to the inlet port 302 via the fluidic passages. Referring to FIG. 3B, in one or more embodiments, the ring-shaped member 300 of the fluid injection device 112 may include the inlet port 302 on a planar side 300-2 of the ring-shaped member 300. Further, the outlet ports 304 may be configured radially at the positions along an outer curved surface 300-1 of the corresponding member 300.

Referring to FIGS. 3C and 3D, front and side views of another ring-shaped fluid injection devices 112 are shown. in one or more embodiments, the fluidic passages within the ring-shaped member 300 may include a first path 306-1 extending at least partially within the ring-shaped member 300 in a radial direction from the inlet port 302. The fluidic passages may further include a second path 306-2 connected to the first path 306-1 and extending circumferentially between each of the outlet ports 304 within the ring-shaped member 300 along the plane (along the radial direction) of the ring-shaped member 300. Further, the fluidic passage may include one or more third paths 306-3, each extending from the second path 306-2 in the radial direction towards one of the outlet ports 304 or the outer curved surface 300-1 such that all the outlet ports 304 remain fluidically connected to the inlet port 302 via the fluidic passages. Referring to FIG. 3D, in one or more embodiments, the ring-shaped member 300 of the fluid injection device 112 may include the inlet port 302 on the outer curved surface 300-2 of the ring-shaped member 300. Further, the outlet ports 304 may be configured radially at the positions along the outer curved surface 300-1 of the corresponding member 300.

Referring to FIGS. 3E and 3F, front and side views of yet another ring-shaped fluid injection devices 112 are shown. In one or more embodiments, the fluidic passages within the ring-shaped member 300 may include a first path 306-1 extending at least partially within the member 300 in a radial direction from the inlet port 302. The fluidic passages may further include a second path 306-2 connected to the first path 306-1 and extending circumferentially between each of the outlet ports 304 within the ring-shaped member 300 along a plane (along the radial direction) of the ring-shaped member 300. Further, the fluidic passage may include one or more third paths 306-3, each extending from the second path 306-2 in an axial direction towards one of the outlet ports 304 or the planar side 300-2 such that all the outlet ports 304 remain fluidically connected to the inlet port 302 via the fluidic passages. Referring to FIG. 3F, in one or more embodiments, the ring-shaped member 300 of the fluid injection device 112 may include the inlet port 302 on the outer curved surface 300-1 of the ring-shaped member 300. Further, the outlet ports 304 may be also configured at the positions on a planar side 300-3 of the corresponding member 300.

Referring to FIGS. 3G and 3H, front and side views of still another ring-shaped fluid injection devices 112 is shown. In one or more embodiments, the fluidic passages within the ring-shaped member 300 may include a first path 306-1 extending at least partially within the member 300 in an axial direction from the inlet port 302. The fluidic passages may further include a second path 306-2 connected to the first path 306-1 and extending circumferentially between each of the outlet ports 304 within the ring-shaped member 300 along a plane (along the radial direction) of the ring-shaped member 300. Further, the fluidic passage may include one or more third paths 306-3, each extending from the second path 306-2 in the same axial direction towards one of the outlet ports 304 such that all the outlet ports 304 remain fluidically connected to the inlet port 302 via the fluidic passages. Referring to FIG. 3H, in one or more embodiments, the ring-shaped member 300 of the fluid injection device 112 may include the inlet port 302 on a planar side 300-2 of the ring-shaped member 300. Further, the outlet ports 304 may be configured at the positions on another planar side 300-3 of the corresponding member 300 such that the inlet port 302 remains on the opposite side of the outlet ports 304.

In one or more embodiments, the size of the outlet ports 304 may be smaller than the size of the inlet port 302 in the fluid injection devices 112 to regulate the outflow of the refrigerant through the outlet ports 304. However, in other embodiments, the size of the outlet ports 304 may also be equal to or greater than the size of the inlet port 302 in the fluid injection devices 112. Further, in one or more embodiments, the size of the outlet ports 304 may also be different.

In one or more embodiments, the outlet ports 304 may be configured at the positions on the fluid injection devices 112 such that upon coaxially configuring the corresponding injection device 112 with respect to the shaft 102, the outlet ports 304 remain above a plane passing through a center of the shaft 102. Accordingly, the outlet ports 304 above the central plane may supply/spray the refrigerant to an upper portion of the stator 106 and the rotor 104. Further, the supplied/sprayed refrigerant may automatically drain from the upper portion towards the bottom portion of the stator 106 and the rotor 104 under the effect of gravity. This arrangement of the outlet ports 304 may help keep the total number of outlet ports 304 lower, while effectively and uniformly supplying the refrigerant to the entire portion of the stator 106 and the rotor 104.

In addition, in one or more embodiments, each of the fluid injection devices 112 may include one or more mounting holes 308 extending axially therethrough. The mounting holes 308 may be configured to facilitate attachment of the corresponding fluid injection devices 112, at the corresponding fluid injection passage 114, 116, to the cover 110 and/or the housing 108 using one or more fasteners 118 as shown in FIG. 1, such that the inlet 302 of the attached injection device 112 gets fluidically connected to the corresponding fluid injection passage 114, 116.

While various embodiments and drawings have been described herein for a semi-hermetic screw compressor, however, the teachings of the subject disclosure are equally applicable to motors associated with other compressors or other screw compressors as well, and all such embodiments are well within the scope of the subject disclosure. In such embodiments (not shown), the compressor may include the motor enclosed within the same cover or housing. The motor may include the rotor having the shaft and the stator arranged around the rotor within the cover. Further, the fluid injection devices may be configured coaxially to the shaft at one or both ends of the shaft within the cover, such that each of the injection devices remains fluidically connected to one of the fluid injection passages extending through the cover.

Further, the teachings of the subject disclosure are equally applicable to motors associated with other types of compressors as well as for motors associated with non-compressor-based applications, without any limitations, and all such embodiments are well within the scope of this subject disclosure.

It is to be appreciated by a person skilled in the art that the fluid injection devices facilitate enhancing the refrigerant injection mechanism into the motor, allowing for a more uniform distribution of the refrigerant without the need for increasing the number of ports within the compressor housing and motor cover. This solution not only facilitates a precise optimization of the injection's direction, location, and flow rate to maximize the cooling effect but also significantly boosts compressor efficiency. By calibrating the amount of liquid utilized for cooling, it ensures minimal waste and reduces viscous loss. Consequently, this optimized cooling process not only conserves resources but also contributes to the overall improvement in the performance and longevity of the motor.

Thus, this subject disclosure overcomes the challenges associated with existing motor cooling systems associated with compressors as well as in general, by providing an improved and space-efficient motor cooling system for screw compressors or semi-hermetic refrigerant screw compressors that addresses the issue of uneven motor cooling and overheating, while also improving the efficiency of the motor cooling process.

While the subject disclosure has been described with reference to exemplary embodiments, it will be understood by those skilled in the art that various changes may be made and equivalents may be substituted for elements thereof without departing from the scope of the subject disclosure as defined by the appended claims. Modifications may be made to adopt a particular situation or material to the teachings of the subject disclosure without departing from the scope thereof. Therefore, it is intended that the subject disclosure not be limited to the particular embodiment disclosed, but that the subject disclosure includes all embodiments falling within the scope of the subject disclosure as defined by the appended claims.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

1. A motor for a compressor, the motor comprising:
a rotor configured over a shaft;
a stator arranged around the rotor within a cover associated with the motor; and
at least one fluid injection device,
wherein the at least one fluid injection device comprises an inlet port and one or more outlet ports, wherein the one or more outlet ports are fluidically connected to the inlet port via a plurality of fluidic passages extending within the corresponding fluid injection device, and
wherein the inlet port of each of the at least one fluid injection device is fluidically connected to a fluid injection passage extending through the cover.

2. The motor of claim 1, wherein the compressor is a screw compressor, and wherein the at least one fluid injection device is configured at one or both ends of the shaft.

3. The motor of claim 1, wherein the compressor is a semi-hermetic screw compressor having a first section of the shaft extending out of a housing of the compressor into the cover, and a second section of the shaft enclosed within the housing.

4. The motor of claim 3, wherein the at least one fluid injection device is configured to flow or spray a refrigerant towards the stator and/or the rotor, at one or both ends of the shaft or the first section of the shaft, through the one or more outlet ports via the corresponding fluidic passages.

5. The motor of claim 1, wherein a ring-shaped fluid injection device among the at least one fluid injection device is fluidically connected to the corresponding fluid injection passage of the cover at one end of the shaft.

6. The motor of claim 3, wherein a ring-shaped fluid injection device among the at least one fluid injection device is fluidically connected with the corresponding fluid injection passage in the housing at an end of the first section of the shaft or an end of the shaft coaxially extending through the ring-shaped fluid injection device.

7. The motor of claim 1, wherein the inlet port is configured axially on a planar side of a ring-shaped member of the at least one fluid injection device, and the one or more outlet ports are configured radially along an outer curved surface of the corresponding ring-shaped member.

8. The motor of claim 1, wherein the inlet port and the one or more outlet ports are configured radially at positions along an outer curved surface of a corresponding ring-shaped member of the at least one fluid injection device.

9. The motor of claim 1, wherein the inlet port is configured radially on an outer curved surface of a ring-shaped member of the at least one fluid injection device, and the one or more outlet ports are configured axially at positions along a planar surface of the corresponding ring-shaped member.

10. The motor of claim 1, wherein a disc-shaped fluid injection device among the at least one fluid injection device is configured with the cover at an end of the shaft, and wherein the inlet port and the one or more outlet ports are defined radially and/or axially along an outer curved surface and/or a planar surface respectively of the disc-shaped fluid injection device.

11. The motor of claim 1, wherein the at least one fluid injection device comprises one or more mounting holes that are configured to fluidically connect the inlet port of the at least one fluid injection device to the corresponding fluid injection passage and to the cover and/or a housing of the motor using one or more fasteners.

12. The motor of claim 1, wherein the size of the one or more outlet ports is less than the size of the inlet port.

13. The motor of claim 1, wherein the at least one fluid injection device is coaxially configured with the shaft, and wherein the one or more outlet ports are positioned above a plane passing through a center of the shaft.

14. A motor for a semi-hermetic screw compressor associated with a vapor compression system, the motor comprising:
a shaft rotatably configured within a housing associated with the compressor, such that a first section of the shaft extends out of the housing and a second section of the shaft remains enclosed within the housing;
a stator and a rotor arranged around the first section of the shaft, wherein the stator, the rotor, and the first section of the shaft are enclosed by a cover attached to the housing; and
at least one fluid injection device configured at one or both ends of the first section of the shaft,
wherein the at least one fluid injection device comprises an inlet port and one or more outlet ports, the one or more outlet ports being fluidically connected to the inlet port via a plurality of fluidic passages extending within the corresponding fluid injection device, and
wherein the inlet port of each of the at least one fluid injection device is fluidically connected to a corresponding fluid injection passage extending through the cover and/or the housing of the motor.

15. The motor of claim 14, wherein the at least one fluid injection device is configured to flow or spray a refrigerant towards the stator and/or the rotor, at one or both ends of the shaft or the first section, through the one or more outlet ports via the corresponding fluidic passages.

16. The motor of claim 14, wherein a ring-shaped fluid injection device among the at least one fluid injection device is fluidically connected to the corresponding fluid injection passage of the cover at one end of the shaft.

17. The motor of claim 14, wherein a ring-shaped fluid injection device among the at least one fluid injection device is fluidically connected with the corresponding fluid injection passage in the housing at an end of the first section of the shaft or an end of the shaft coaxially extending through the ring-shaped fluid injection device.

18. The motor of claim 14, wherein the inlet port is configured axially on a planar side of a ring-shaped member of the at least one fluid injection device, and the one or more outlet ports are configured radially at positions along an outer curved surface of the corresponding ring-shaped member.

19. The motor of claim 14, wherein the size of the one or more outlet ports is greater than the size of the inlet port.

20. The motor of claim 14, wherein the at least one fluid injection device is coaxially configured at the one or both ends of the first section of the shaft, and wherein the one or more outlet ports are positioned above a plane passing through a center of the shaft.
